(19) United States
(12) Patent Application Publication
(10) Pub. No.: US 2018/0196647 A1
(43) Pub. Date: Jul. 12, 2018

(54) Application Programming Interface Discovery Using Pattern Recognition

(71) Applicant: International Business Machines Corporation, Armonk, NY (US)

(72) Inventors: Mark D. Batinich, North Aurora, IL (US); Pietro Iannucci, Roma (IT); Linwood E. Loving, Mechanicsville, VA (US); Luigi Pichetti, Roma (IT)

(21) Appl. No.: 15/401,558

(22) Filed: Jan. 9, 2017

(51) Int. Cl. G06F 9/45; G06F 9/54

(52) U.S. Cl. CPC G06F 8/40; G06F 9/541

(57) ABSTRACT

Transforming application programming interface calls is provided. An application programming interface discovery process is performed on a second data processing system to determine how a task corresponding to a service request received from a first data processing system is performed on the second data processing system. An application programming interface call integration pattern is selected based on the application programming interface discovery process. The selected application programming interface call integration pattern corresponds to application programming interface calls and associated data that are same or similar to an application programming interface call and associated data included in the service request. The selected application programming interface call integration pattern is utilized to transform the application programming interface call and associated data included in the service request into a transformed application programming interface call and associated data that the second data processing system uses to perform the task.

### BACKGROUND

### 1. Field

The disclosure relates generally to application programming interfaces and more specifically to transforming an application programming interface call and associated data, which are included in a service request received from a source data processing system to perform a task or function on a target data processing system, into a transformed application programming interface call and associated data, which the target data processing system can utilize to perform the task or function corresponding to the service request, using application programming interface call integration pattern code corresponding to same or similar application programming interface calls and associated data to the application programming interface call and associated data included in the service request.

### 2. Description of the Related Art

An application programming interface (API) is a set of routines, protocols, and tools for building software applications. An application programming interface makes it easier to develop a software application by providing all the basic building blocks. An application developer then puts the building blocks together to create a software application. In essence, an application's application program interface defines the proper way for the developer to request services from that application. Documentation for the application programming interface is usually provided to facilitate usage of the application programming interface.

Application programming interfaces may be used for accessing a Web-based software service or a Web tool. Using application program interfaces, applications are able to talk to each other without any user knowledge or intervention. For example, when a user buys movie tickets online and enters credit card information, the movie ticket Web site uses an application program interface to send the credit card information to a remote application that verifies whether the credit card information is correct. Once payment is confirmed, the remote application sends a response back to the movie ticket Web site indicating that the move ticket Web site may issue the tickets to the user. The user only sees the movie ticket Web site interface, but behind the scenes many applications are working together using application program interfaces to provide the service.

Application programming interface documentation describes what services an application programming interface offers and how to use those services. Documentation provides for the development and maintenance of applications that use the application programming interface. Application programming interface documentation is typically found in documentation files. However, the types of content included in the documentation differ from application programming interface to application programming interface. To facilitate understanding, application programming interface documentation can include description of classes and methods in the application programming interface, as well as, typical usage scenarios, code snippets, design rationales, performance discussions, and contracts. Restrictions and limitations on how the application programming interface can be used are also covered by the documentation. For example, documentation for an application programming interface function could note that its parameters cannot be null, or that the function itself is not thread safe. Further, application programming interface documentation can be supplemented with metadata, such as, for example, object-oriented annotations. This metadata can be used by a run-time environment to implement custom behaviors or custom handling.

However, many more application programming interface definitions exist than an application developer can learn and understand how to use. As a result, application developers are required to spend several months learning what application programming interfaces are available for use and what they do. In addition, it is also very difficult to understand what documentation data is available with certain application programming interfaces to enable integration with other application programming interface services.

### SUMMARY

According to one illustrative embodiment, a computer-implemented method for transforming application programming interface calls is provided. A computer performs an application programming interface discovery process on a second data processing system to determine how a task corresponding to a service request received from a first data processing system is performed on the second data processing system. The computer selects an application programming interface call integration pattern from a set of application programming interface call integration patterns, the selected application programming interface call integration pattern corresponding to application programming interface calls and associated data that are same or similar to an application programming interface call and associated data included in the service request received from the first data processing system, based on the application programming interface discovery process on the second data processing system determining how the task corresponding to the service request is performed on the second data processing system. The computer utilizes the selected application programming interface call integration pattern to transform the application programming interface call and associated data included in the service request received from the first data processing system into a transformed application programming interface call and associated data that the second data processing system uses to perform the task corresponding to the service request. The computer sends the transformed application programming interface call and associated data via a network to the second data processing system to perform the task corresponding to the service request. The computer receives, via the network, a result of the second data processing system performing the task corresponding to the service request using the transformed application programming interface call and associated data. The computer sends the result of the second data processing system performing the task corresponding to the service request to the first data processing system via the network. According to other illustrative embodiments, a computer system and computer program product for transforming application programming interface calls are provided.

Thus, the different illustrative embodiments provide a mechanism to simplify application programming interface call integration across different data processing environments. By utilizing the different illustrative embodiments, clients may manage services in these different data processing environments in a common way regardless of where service workload is run. In addition, the different illustrative embodiments may enable clients to plug and play services more quickly at a decreased cost. Consequently, the different illustrative embodiments provide an automated deployment and management framework to manage application programming interface call integration between different services provided by disparate application programming interfaces.

### BRIEF DESCRIPTION OF THE DRAWINGS

FIG. 1 is a pictorial representation of a network of data processing systems in which illustrative embodiments may be implemented;

FIG. 2 is a diagram of a data processing system in which illustrative embodiments may be implemented;

FIG. 3 is a diagram illustrating a cloud computing environment in which illustrative embodiments may be implemented;

FIG. 4 is a diagram illustrating an example of abstraction layers of a cloud computing environment in accordance with an illustrative embodiment;

FIG. 5 is a diagram illustrating an example of an application programming interface call transformation system in accordance with an illustrative embodiment; and

FIGS. 6A-6B are a flowchart illustrating a process for transforming application programming interface calls and associated data in accordance with an illustrative embodiment.

### DETAILED DESCRIPTION

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

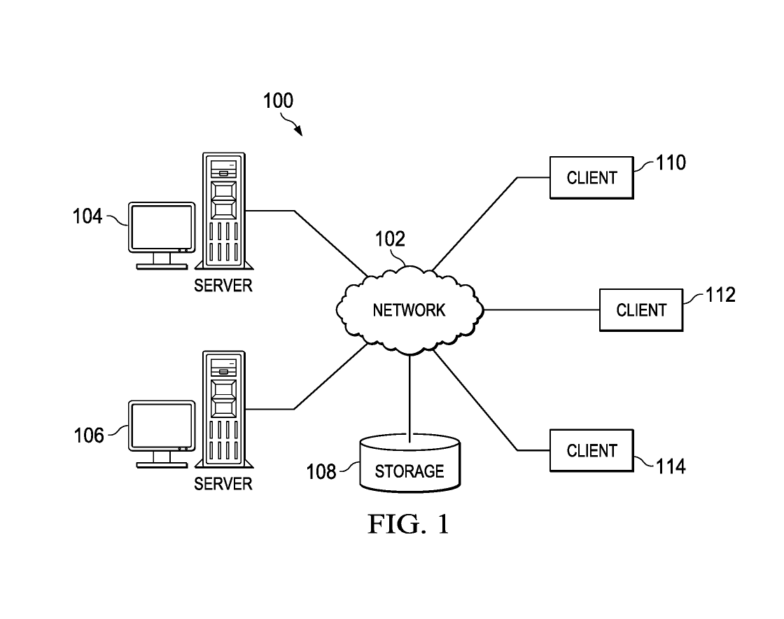

With reference now to the figures, and in particular, with reference to FIGS. 1-5, diagrams of data processing environments are provided in which illustrative embodiments may be implemented. It should be appreciated that FIGS. 1-5 are only meant as examples and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers, data processing systems, and other devices in which the illustrative embodiments may be implemented. Network data processing system 100 contains network 102, which is the medium used to provide communications links between the computers, data processing systems, and other devices connected together within network data processing system 100. Network 102 may include connections, such as, for example, wire communication links, wireless communication links, and fiber optic cables.

In the depicted example, server 104 and server 106 connect to network 102, along with storage 108. Server 104 and server 106 may be, for example, server computers with high-speed connections to network 102. In addition, server 104 and server 106 may, for example, monitor and manage integration of disparate application programming interface calls between different services provided by different client devices. Also, it should be noted that server 104 and server 106 may each represent a plurality of servers hosting application programming interface call integration management services.

Client 110, client 112, and client 114 also connect to network 102. Clients 110, 112, and 114 are clients of server 104 and server 106. Clients 110, 112, and 114 may each represent a data processing system, such as a network computer, or a data processing system environment, such as a data center environment or a cloud environment. In addition, clients 110, 112, and 114 may each provide a set of different services. The set of services may include any type of network or online services, such as event monitoring services, problem ticket generation services, financial services, reservation services, purchase transaction services, data services, and the like. Further, the set of services may be included in a microservice architecture comprising a plurality of different microservices provided by a multitude of application programming interfaces. A microservice architecture is a suite of independently deployable, small, modular services in which each microservice runs a unique process to serve a business goal.

As an example, a service located on client 110 may require data provided by a service located on client 112. As a result, the application programming interface corresponding to the service provided by client 110 makes a service request that includes an application programming interface call to a target application programming interface corresponding to the service provided by client 112. However, in this example the target application programming interface of client 112 does not understand the application programming interface call made by the source application programming interface of client 110. Consequently, the target application programming interface of client 112 is not able to perform its function of providing the data required by the source application programming interface of client 110 to perform its service.

Using illustrative embodiments, server 104 or server 106 transform the application programming interface call made by the source application programming interface into a transformed or modified application programming interface call that the target application programming interface can understand and use. Server 104 or server 106 transform the application programming interface call by utilizing application programming interface call integration pattern code. An application programming interface call integration pattern is an abstraction layer of application programming interface code that shields an application developer from the many different specific variations that different application programming interface vendors or providers offer around common application programming interface patterns, such as, for example, event log forwarding application programming interfaces, problem ticket generation application programming interfaces, and the like. The abstraction layer is a generalization of an application programming interface away from any specific implementation. This generalization arises from similarities that are captured by a pattern expressing the similarities present in various specific application programming interface implementations.

The application programming interface call integration pattern code, which provides the abstraction layer, is application programming interface vendor or provider agnostic (i.e., not aware of any specific vendor or provider API implementation). In addition, even though application programming interface call integration pattern code is vendor or provider agnostic, each set of application programming interface call integration pattern code addresses a domain specific integration scenario. In other words, the application developer may utilize a particular set of application programming interface call integration pattern code for a given application programming interface function, such as, for example, generating problem tickets based on forwarded event monitoring logs, and avoid learning the specific implementations provided by the different application programming interface vendors, thereby building more robust integrations. Illustrative embodiments generate the application programming interface call integration pattern code based on application programming interface discovery, which is achieved via patterns with focused search exploration, limiting the number of application programming interfaces and associated data that illustrative embodiments have to look at. As a result, illustrative embodiments decrease processor utilization, which saves computer resources and increases performance of the computer, itself. Further, illustrative embodiments may increase service response times and decrease network latency.

Storage 108 is a network storage device capable of storing any type of data in a structured format or an unstructured format. In addition, storage 108 may represent a plurality of network storage devices. Further, storage 108 may store identifiers and Internet protocol addresses for a plurality of client devices, a plurality of different microservice architectures, a plurality of different application programming interfaces and corresponding application programming interface documentation data for each different application programming interface, a plurality of different application programming interface call integration pattern code, and the like. Furthermore, storage unit 108 may store other types of data, such as authentication or credential data that may include user names, passwords, and biometric data associated with system administrators, for example.

In addition, it should be noted that network data processing system 100 may include any number of additional servers, clients, storage devices, and other devices not shown. Program code located in network data processing system 100 may be stored on a computer readable storage medium and downloaded to a computer or other data processing device for use. For example, program code may be stored on a computer readable storage medium on server 104 and downloaded to client 110 over network 102 for use on client 110.

In the depicted example, network data processing system 100 may be implemented as a number of different types of communication networks, such as, for example, an internet, an intranet, a local area network (LAN), and a wide area network (WAN). FIG. 1 is intended as an example only, and not as an architectural limitation for the different illustrative embodiments.

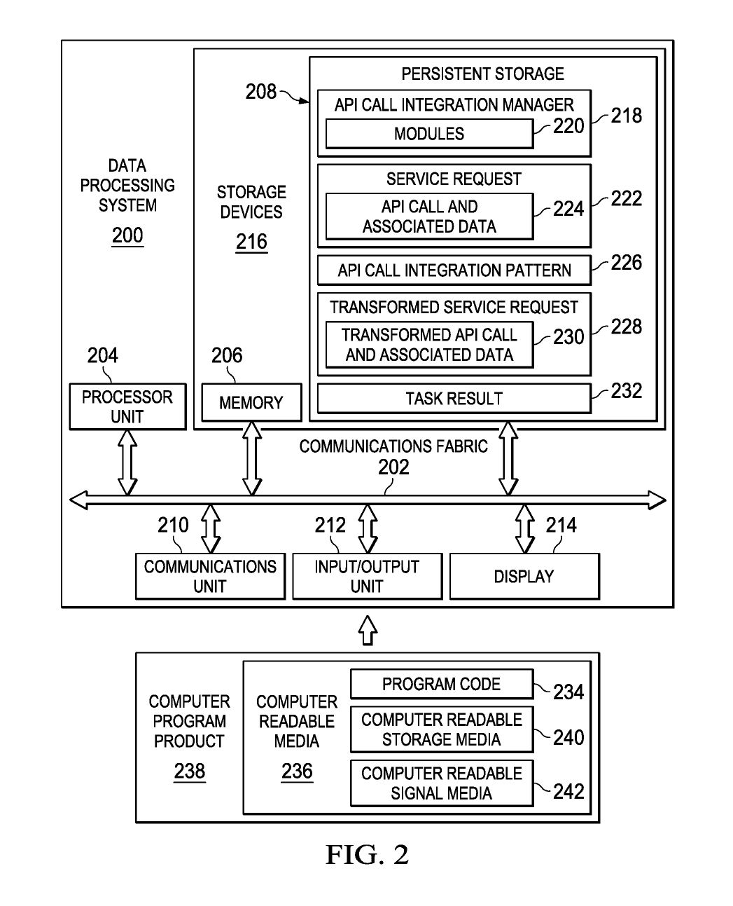

With reference now to FIG. 2, a diagram of a data processing system is depicted in accordance with an illustrative embodiment. Data processing system 200 is an example of a computer, such as client 110 in FIG. 1, in which computer readable program code or instructions implementing processes of illustrative embodiments may be located. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software applications and programs that may be loaded into memory 206. Processor unit 204 may be a set of one or more hardware processor devices or may be a multi-processor core, depending on the particular implementation. Further, processor unit 204 may be implemented using one or more heterogeneous processor systems, in which a main processor is present with secondary processors on a single chip. As another illustrative example, processor unit 204 may be a symmetric multi-processor system containing multiple processors of the same type.

Memory 206 and persistent storage 208 are examples of storage devices 216. A computer readable storage device is any piece of hardware that is capable of storing information, such as, for example, without limitation, data, computer readable program code in functional form, and/or other suitable information either on a transient basis and/or a persistent basis. Further, a computer readable storage device excludes a propagation medium. Memory 206, in these examples, may be, for example, a random access memory, or any other suitable volatile or non-volatile storage device. Persistent storage 208 may take various forms, depending on the particular implementation. For example, persistent storage 208 may contain one or more devices. For example, persistent storage 208 may be a hard drive, a flash memory, a rewritable optical disk, a rewritable magnetic tape, or some combination of the above. The media used by persistent storage 208 may be removable. For example, a removable hard drive may be used for persistent storage 208.

In this example, persistent storage 208 stores application programming interface call integration manager 218. However, it should be noted that even though application programming interface call integration manager 218 is illustrated as residing in persistent storage 208, in an alternative illustrative embodiment application programming interface call integration manager 218 may be a separate component of data processing system 200. For example, application programming interface call integration manager 218 may be a hardware component coupled to communication fabric 202 or a combination of hardware and software components.

Application programming interface call integration manager 218 controls the process of transforming application programming interface calls, which are included in service requests received from source data processing systems to perform functions on target data processing systems, into application programming interface calls that the target data processing systems can utilize to perform the functions corresponding to the service requests by using application programming interface call integration pattern code corresponding to same or similar application programming interface calls to the application programming interface calls included in the service requests. Application programming interface call integration manager 218 includes modules 220. Modules 220 represent a plurality of software modules that perform different processes during the transformation and integration of application programming interface calls. Modules 220 may include, for example, an application programming interface call listener module, an application programming interface call parser module, an application programming interface call and integration pattern search engine module, an application programming interface discovery engine module, an application programming interface call transformer module, and a transformed application programming interface call sender module. However, it should be noted that modules 220 may include any type of software module necessary for transforming integrating application programming interface calls.

Application programming interface call integration manager 218 receives service request 222 from a source computer, such as client 110 in FIG. 1. A user of the source computer may manually send service request 222. Alternatively, a source application programming interface corresponding to a service provided by the source computer may automatically send service request 222. Service request 222 represents a call for a target application programming interface located on a target computer, such as client 112 in FIG. 1, to perform a service function. Service request 222 includes application programming interface call and associated data 224.

However, application programming interface call integration manager 218 determines, for example, that the target application programming interface located on the target computer cannot read or utilize service request 222 based on application programming interface call integration manager 218 performing an application programming interface discovery process on the target computer. As a result, application programming interface call integration manager 218 searches a repository for application programming interface call integration pattern 226. Application programming interface call integration pattern 226 is program code for an abstraction of the target application programming interface corresponding to application programming interface call and associated data 224. It should be noted that if application programming interface call integration manager 218 does not find application programming interface call integration pattern 226 in the search of the repository (e.g., application programming interface call integration pattern 226 has not been generated and stored), then application programming interface call integration manager 218 may utilize the application programming interface discovery engine module to analyze the target application programming interface and associated documentation data, extract the relevant data for the given domain from the target application programming interface and the associated documentation data, and generate application programming interface call integration pattern 226. Also, it should noted that application programming interface call integration pattern 226 represents a plurality of different application programming interface call integration patterns.

Application programming interface call integration manager 218 utilizes application programming interface call integration pattern 226 to generate transformed service request 228 that includes transformed application programming interface call and associated data 230. Transformed service request 228, which includes transformed application programming interface call and associated data 230, corresponds to service request 222, which includes application programming interface call and associated data 224. The target application programming interface on the target computer is able to read and utilize transformed application programming interface call and associated data 230.

Subsequently, application programming interface call integration manager 218 receives task result 232 from the target application programming interface. Task result 232 represents a result of the target application programming interface performing the service function corresponding to transformed service request 228. Task result 232 may simply be a notification that the service function was performed by the target application programming interface on the target computer. However, task result 232 may include data that needs to be processed by the source application programming interface on the source computer. In this situation, application programming interface call integration manager 218 performs a similar process to transform a call from the target application programming interface to a call that the source application programming interface can read and utilize.

Communications unit 210, in this example, provides for communication with other computers, data processing systems, and devices via a network, such as network 102 in FIG. 1. Communications unit 210 may provide communications through the use of both physical and wireless communications links. The physical communications link may utilize, for example, a wire, cable, universal serial bus, or any other physical technology to establish a physical communications link for data processing system 200. The wireless communications link may utilize, for example, shortwave, high frequency, ultra high frequency, microwave, wireless fidelity (Wi-Fi), bluetooth technology, global system for mobile communications (GSM), code division multiple access (CDMA), second-generation (2G), third-generation (3G), fourth-generation (4G), 4G Long Term Evolution (LTE), LTE Advanced, or any other wireless communication technology or standard to establish a wireless communications link for data processing system 200.

Input/output unit 212 allows for the input and output of data with other devices that may be connected to data processing system 200. For example, input/output unit 212 may provide a connection for user input through a keypad, a keyboard, a mouse, and/or some other suitable input device. Display 214 provides a mechanism to display information to a user and may include touch screen capabilities to allow the user to make on-screen selections through user interfaces or input data, for example.

Instructions for the operating system, applications, and/or programs may be located in storage devices 216, which are in communication with processor unit 204 through communications fabric 202. In this illustrative example, the instructions are in a functional form on persistent storage 208. These instructions may be loaded into memory 206 for running by processor unit 204. The processes of the different embodiments may be performed by processor unit 204 using computer-implemented instructions, which may be located in a memory, such as memory 206. These program instructions are referred to as program code, computer usable program code, or computer readable program code that may be read and run by a processor in processor unit 204. The program instructions, in the different embodiments, may be embodied on different physical computer readable storage devices, such as memory 206 or persistent storage 208.

Program code 234 is located in a functional form on computer readable media 236 that is selectively removable and may be loaded onto or transferred to data processing system 200 for running by processor unit 204. Program code 234 and computer readable media 236 form computer program product 238. In one example, computer readable media 236 may be computer readable storage media 240 or computer readable signal media 242. Computer readable storage media 240 may include, for example, an optical or magnetic disc that is inserted or placed into a drive or other device that is part of persistent storage 208 for transfer onto a storage device, such as a hard drive, that is part of persistent storage 208. Computer readable storage media 240 also may take the form of a persistent storage, such as a hard drive, a thumb drive, or a flash memory that is connected to data processing system 200. In some instances, computer readable storage media 240 may not be removable from data processing system 200.

Alternatively, program code 234 may be transferred to data processing system 200 using computer readable signal media 242. Computer readable signal media 242 may be, for example, a propagated data signal containing program code 234. For example, computer readable signal media 242 may be an electro-magnetic signal, an optical signal, and/or any other suitable type of signal. These signals may be transmitted over communication links, such as wireless communication links, an optical fiber cable, a coaxial cable, a wire, and/or any other suitable type of communications link. In other words, the communications link and/or the connection may be physical or wireless in the illustrative examples. The computer readable media also may take the form of non-tangible media, such as communication links or wireless transmissions containing the program code.

In some illustrative embodiments, program code 234 may be downloaded over a network to persistent storage 208 from another device or data processing system through computer readable signal media 242 for use within data processing system 200. For instance, program code stored in a computer readable storage media in a data processing system may be downloaded over a network from the data processing system to data processing system 200. The data processing system providing program code 234 may be a server computer, a client computer, or some other device capable of storing and transmitting program code 234.

The different components illustrated for data processing system 200 are not meant to provide architectural limitations to the manner in which different embodiments may be implemented. The different illustrative embodiments may be implemented in a data processing system including components in addition to, or in place of, those illustrated for data processing system 200. Other components shown in FIG. 2 can be varied from the illustrative examples shown. The different embodiments may be implemented using any hardware device or system capable of executing program code. As one example, data processing system 200 may include organic components integrated with inorganic components and/or may be comprised entirely of organic components excluding a human being. For example, a storage device may be comprised of an organic semiconductor.

As another example, a computer readable storage device in data processing system 200 is any hardware apparatus that may store data. Memory 206, persistent storage 208, and computer readable storage media 240 are examples of physical storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that may be present in communications fabric 202.

It is understood that although this disclosure includes a detailed description on cloud computing, implementation of the teachings recited herein are not limited to a cloud computing environment. Rather, illustrative embodiments are capable of being implemented in conjunction with any other type of computing environment now known or later developed. Cloud computing is a model of service delivery for enabling convenient, on-demand network access to a shared pool of configurable computing resources, such as, for example, networks, network bandwidth, servers, processing, memory, storage, applications, virtual machines, and services, which can be rapidly provisioned and released with minimal management effort or interaction with a provider of the service. This cloud model may include at least five characteristics, at least three service models, and at least four deployment models.

The characteristics may include, for example, on-demand self-service, broad network access, resource pooling, rapid elasticity, and measured service. On-demand self-service allows a cloud consumer to unilaterally provision computing capabilities, such as server time and network storage, as needed automatically without requiring human interaction with the service's provider. Broad network access provides for capabilities that are available over a network and accessed through standard mechanisms that promote use by heterogeneous thin or thick client platforms, such as, for example, mobile phones, laptops, and personal digital assistants. Resource pooling allows the provider's computing resources to be pooled to serve multiple consumers using a multi-tenant model, with different physical and virtual resources dynamically assigned and reassigned according to demand. There is a sense of location independence in that the consumer generally has no control or knowledge over the exact location of the provided resources, but may be able to specify location at a higher level of abstraction, such as, for example, country, state, or data center. Rapid elasticity provides for capabilities that can be rapidly and elastically provisioned, in some cases automatically, to quickly scale out and rapidly released to quickly scale in. To the consumer, the capabilities available for provisioning often appear to be unlimited and can be purchased in any quantity at any time. Measured service allows cloud systems to automatically control and optimize resource use by leveraging a metering capability at some level of abstraction appropriate to the type of service, such as, for example, storage, processing, bandwidth, and active user accounts. Resource usage can be monitored, controlled, and reported providing transparency for both the provider and consumer of the utilized service.

Service models may include, for example, Software as a Service (SaaS), Platform as a Service (PaaS), and Infrastructure as a Service (IaaS). Software as a Service is the capability provided to the consumer to use the provider's applications running on a cloud infrastructure. The applications are accessible from various client devices through a thin client interface, such as a web browser (e.g., web-based e-mail). The consumer does not manage or control the underlying cloud infrastructure including network, servers, operating systems, storage, or even individual application capabilities, with the possible exception of limited user-specific application configuration settings. Platform as a Service is the capability provided to the consumer to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations. Infrastructure as a Service is the capability provided to the consumer to provision processing, storage, networks, and other fundamental computing resources where the consumer is able to deploy and run arbitrary software, which can include operating systems and applications. The consumer does not manage or control the underlying cloud infrastructure, but has control over operating systems, storage, deployed applications, and possibly limited control of select networking components, such as, for example, host firewalls.

Deployment models may include, for example, a private cloud, community cloud, public cloud, and hybrid cloud. A private cloud is a cloud infrastructure operated solely for an organization. The private cloud may be managed by the organization or a third party and may exist on-premises or off-premises. A community cloud is a cloud infrastructure shared by several organizations and supports a specific community that has shared concerns, such as, for example, mission, security requirements, policy, and compliance considerations. The community cloud may be managed by the organizations or a third party and may exist on-premises or off-premises. A public cloud is a cloud infrastructure made available to the general public or a large industry group and is owned by an organization selling cloud services. A hybrid cloud is a cloud infrastructure composed of two or more clouds, such as, for example, private, community, and public clouds, which remain as unique entities, but are bound together by standardized or proprietary technology that enables data and application portability, such as, for example, cloud bursting for load-balancing between clouds.

A cloud computing environment is service oriented with a focus on statelessness, low coupling, modularity, and semantic interoperability. At the heart of cloud computing is an infrastructure comprising a network of interconnected nodes.

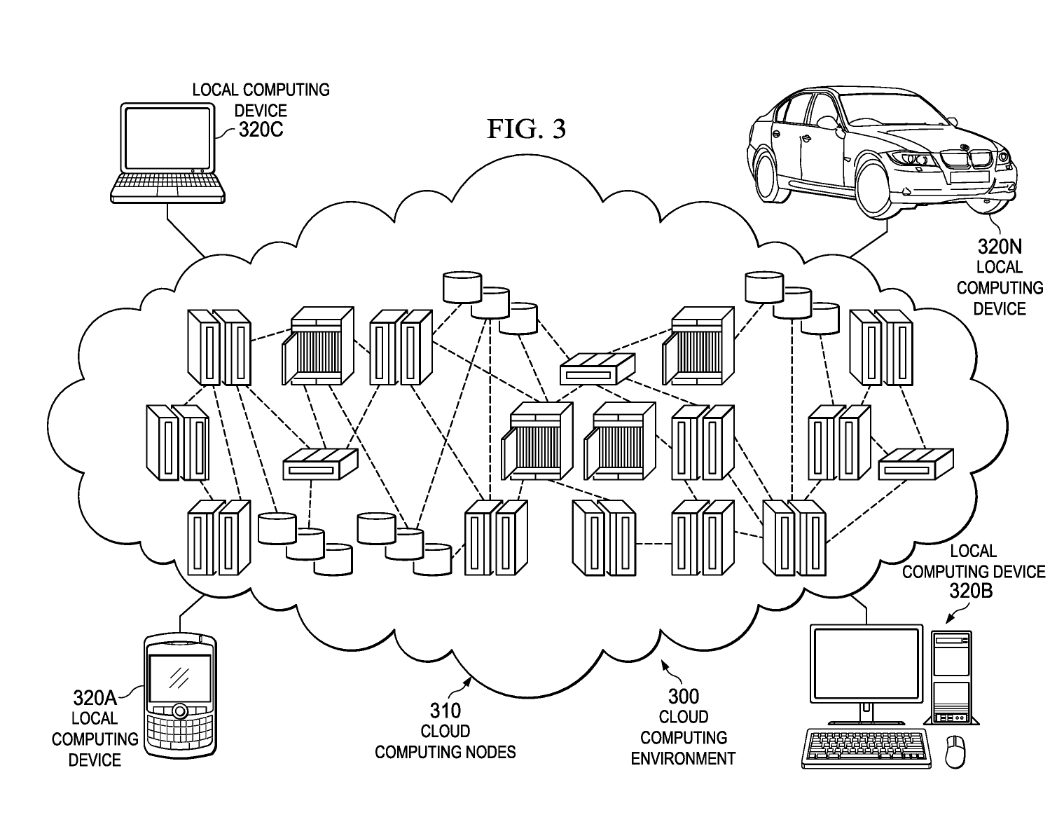

With reference now to FIG. 3, a diagram illustrating a cloud computing environment is depicted in which illustrative embodiments may be implemented. In this illustrative example, cloud computing environment 300 includes a set of one or more cloud computing nodes 310 with which local computing devices used by cloud consumers, such as, for example, personal digital assistant or a smart phone 320A, desktop computer 320B, laptop computer 320C, and/or automobile computer system 320N, may communicate. Cloud computing nodes 310 may be, for example, server 104 and server 106 in FIG. 1. Local computing devices 320A-320N may be, for example, clients 110-114 in FIG. 1.

Cloud computing nodes 310 may communicate with one another and may be grouped physically or virtually into one or more networks, such as private, community, public, or hybrid clouds as described hereinabove, or a combination thereof. This allows cloud computing environment 300 to offer infrastructure, platforms, and/or software as services for which a cloud consumer does not need to maintain resources on a local computing device, such as local computing devices 320A-320N. It is understood that the types of local computing devices 320A-320N are intended to be illustrative only and that cloud computing nodes 310 and cloud computing environment 300 can communicate with any type of computerized device over any type of network and/or network addressable connection using a web browser, for example.

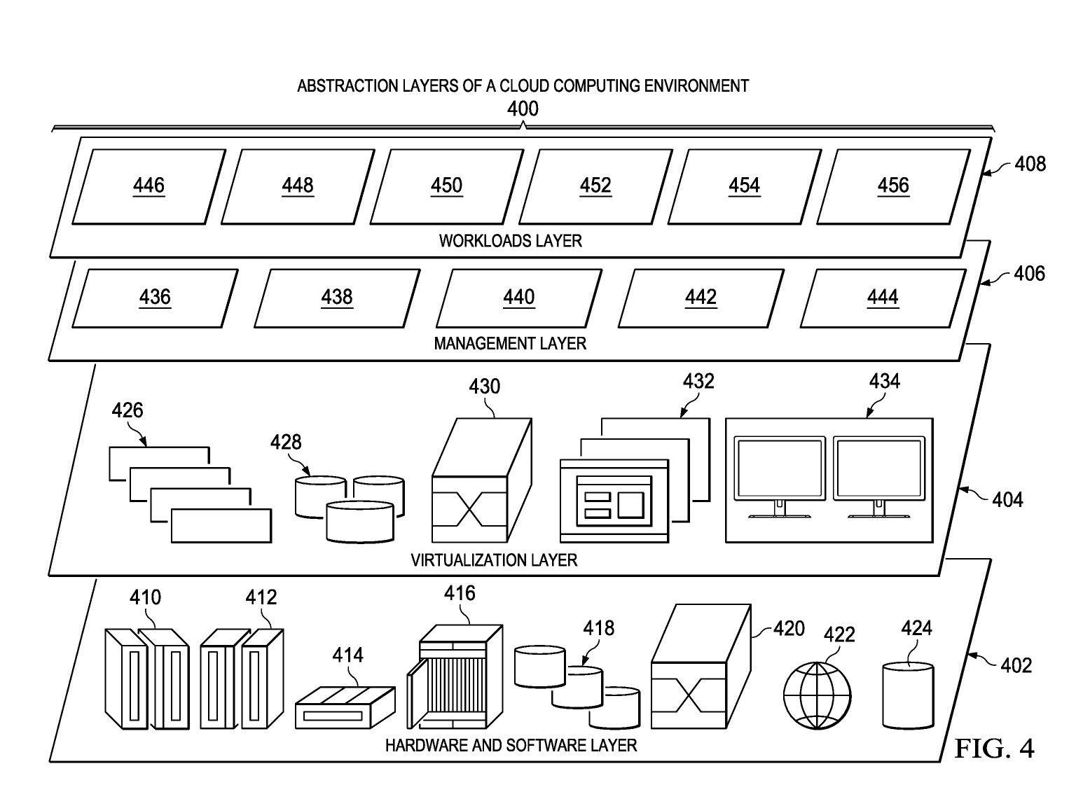

With reference now to FIG. 4, a diagram illustrating abstraction model layers is depicted in accordance with an illustrative embodiment. The set of functional abstraction layers shown in this illustrative example may be provided by a cloud computing environment, such as cloud computing environment 300 in FIG. 3. It should be understood in advance that the components, layers, and functions shown in FIG. 4 are intended to be illustrative only and embodiments of the invention are not limited thereto. As depicted, the following layers and corresponding functions are provided.

Abstraction layers of a cloud computing environment 400 includes hardware and software layer 402, virtualization layer 404, management layer 406, and workloads layer 408. Hardware and software layer 402 includes the hardware and software components of the cloud computing environment. The hardware components may include, for example, mainframes 410, RISC (Reduced Instruction Set Computer) architecture-based servers 412, servers 414, blade servers 416, storage devices 418, and networks and networking components 420. In some illustrative embodiments, software components may include, for example, network application server software 422 and database software 424.

Virtualization layer 404 provides an abstraction layer from which the following examples of virtual entities may be provided: virtual servers 426; virtual storage 428; virtual networks 430, including virtual private networks; virtual applications and operating systems 432; and virtual clients 434.

In one example, management layer 406 may provide the functions described below. Resource provisioning 436 provides dynamic procurement of computing resources and other resources, which are utilized to perform tasks within the cloud computing environment. Metering and pricing 438 provides cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 440 provides access to the cloud computing environment for consumers and system administrators. Service level management 442 provides cloud computing resource allocation and management such that required service levels are met. Service level agreement (SLA) planning and fulfillment 444 provides pre-arrangement for, and procurement of, cloud computing resources for which a future requirement is anticipated in accordance with an SLA.

Workloads layer 408 provides examples of functionality for which the cloud computing environment may be utilized. Example workloads and functions, which may be provided by workload layer 408, may include mapping and navigation 446, software development and lifecycle management 448, virtual classroom education delivery 450, data analytics processing 452, transaction processing 454, and application programming interface call integration processing 456.

Illustrative embodiments provide an application programming interface discovery engine with an application programming interface pattern and service recognition capability. Illustrative embodiments perform discovery on a plurality of application programming interfaces to correlate same or similar services provided by the application programming interfaces and assess data properties associated with the application programming interfaces to fine tune application programming interface pattern matching, service definitions, and the associated data. Illustrative embodiments utilize application programming interface call integration pattern code and related tool sets, which illustrative embodiments may deploy as an iterative process, to simplify application programming interface call integration across cloud and hybrid data processing environments. Illustrative embodiments generate the application programming interface call integration pattern code to be application programming interface vendor or provider agnostic, while addressing domain specific application programming interface call integration scenarios.

Illustrative embodiments utilize the application programming interface discovery engine to analyze any vendor specific application programming interface implementation for a given domain, such as, for example, forwarding an event log application programming interface provided by a particular vendor, and generate application programming interface call integration pattern code, which illustrative embodiments instantiate in a vendor agnostic manner. Illustrative embodiments then use the application programming interface call integration pattern code to transform application programming interface calls received from a source data processing system into application programming interface calls that a target data processing system can read and use to perform a service provided by a corresponding application programming interface on the target data processing system.

Illustrative embodiments achieve the application programming interface discovery using the application programming interface pattern and service recognition and, therefore, enable focused application programming interface exploration and matching to “what is needed” with respect to the broader set of information regarding “what can be discovered”. Illustrative embodiments map the application programming interface patterns to different application programming interface calls, store the mapping information in a repository, and then automate the process of application programming interface call integration using the stored mapping information. The application programming interface discovery engine searches for typical patterns, such as, for example, forwarding event log application programming interfaces provided by a plurality of different service providers, event source configuration information, event source performance information, service provider notifications, service provider configuration information, and the like.

As a result, the application programming interface discovery engine, with pattern-driven search, limits the exploration in what to look for. For example, as the application programming interface discovery engine explores a specific application programming interface implementation provided by a particular application programming interface vendor or provider, the application programming interface discovery engine only extracts application programming interface associated data, which are relevant to a given domain, and later exposes the extracted data through the generic abstraction layer of the application programming interface call integration pattern code construct. Illustrative embodiments expose the application programming interface call integration pattern code in a repository to manage application programming interface call integration across a set of vendor-abstracted representational state transfer (REST)-microservices, which are reusable across vendors and loosely coupled, in hybrid and cloud-based data processing environments. RESTful Web services are a way to provide interoperability between computer systems on the Internet. REST-compliant web services allow requesting systems to access and manipulate textual representations of web resources using a uniform and predefined set of stateless operations.

Thus, illustrative embodiments provide a mechanism to simplify application programming interface call integration across hybrid and cloud-based data processing environments. By utilizing illustrative embodiments, clients may manage services in these hybrid and cloud environments in a common way regardless of where the service workload is being run. In addition, illustrative embodiments may enable clients to plug and play services more quickly at a decreased cost. Furthermore, illustrative embodiments provide a repository that stores a plurality of different application programming interface call integration pattern code for immediate use. Consequently, illustrative embodiments provide an automated deployment and management framework to manage application programming interface call integration between different services provided by disparate application programming interfaces.

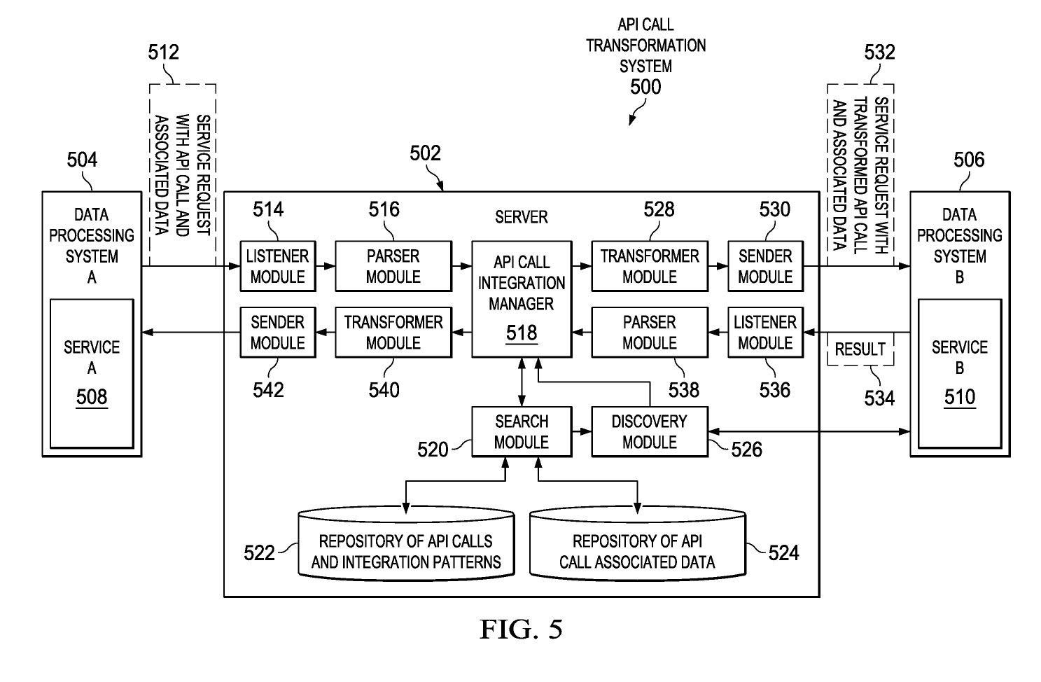

With reference now to FIG. 5, a diagram illustrating an example of an application programming interface call transformation system is depicted in accordance with an illustrative embodiment. Application programming interface call transformation system 500 may be implemented in a network of data processing systems, such as network data processing system 100 in FIG. 1, or a cloud computing environment, such as cloud computing environment 300 in FIG. 3. Application programming interface call transformation system 500 is a system of hardware and software components for transforming application programming interface calls and associated data, which are included in service requests received from source data processing systems to perform tasks on target data processing systems, into transformed application programming interface calls and associated data that the target data processing systems utilize to perform the tasks corresponding to the service requests by using application programming interface call integration patterns corresponding to the application programming interface calls and associated data included in the service request.

In this example, application programming interface call transformation system 500 includes server 502, data processing system A 504, and data processing system B 506. However, it should be noted that application programming interface call transformation system 500 may include any number of servers, clients, and other data processing systems than illustrated. Server 502 may be, for example, server 104 in FIG. 1, data processing system 200 in FIG. 2, or a cloud computing node in cloud computing nodes 310 in FIG. 3. Data processing system A 504 and data processing system B 506 may be, for example, clients 110 and 112 in FIG. 1 or local or cloud computing devices in cloud computing environment 300 in FIG. 3.

Data processing system A 504 provides service A 508 using an application programming interface. Service A 508 may be, for example, an event monitoring application programming interface service that forwards event monitoring logs to service B 510 of data processing system B 506. Service B 510 may be, for example, an incident ticket generation application programming interface service.

Data processing system A 504 makes a connection to listener module 514 of server 502 and sends service request with application programming interface call and associated data 512 for performance of the task by service B 510 of generating an incident ticket on data processing system B 506. Listener module 514 may be, for example, a RESTful Web service listener that accepts RESTful Web service calls to any resource in a data processing system environment, such as a cloud environment, in any possible machine-readable format. Listener module 514 holds the connection with data processing system A 504 and sends service request with application programming interface call and associated data 512 to parser module 516. Parser module 516 parses or breaks down service request with application programming interface call and associated data 512 into searchable data fields to be processed by application programming interface call integration manager 518. Parser module 516 may utilize, for example, natural language processing to parse service request with application programming interface call and associated data 512 into the searchable data fields.

Application programming interface call integration manager 518 may be, for example, application programming interface call integration manager 218 in FIG. 2. Application programming interface call integration manager 518 processes the searchable data fields to determine the type of the service request. After determining the type of service request, application programming interface call integration manager 518 determines whether an application programming interface call integration pattern has been identified for this type of service request. The application programming interface call integration pattern may be, for example, application programming interface call integration pattern 226 in FIG. 2.

If application programming interface call integration manager 518 determines that an application programming interface call integration pattern has not been previously identified for this type of service request, then application programming interface call integration manager 518 forwards the searchable data to search module 520. Search module 520 may be, for example, an application programming interface call and integration pattern search engine. Search module 520 searches repository of application programming interface call and integration patterns 522 and repository of application programming interface call associated data 524 to identify a set of one or more application programming interface call integration patterns corresponding to service request with application programming interface call and associated data 512.

Search module 520 forwards the identified set of application programming interface call integration patterns to discovery module 526. Discovery module 526 may be, for example, an application programming interface discovery engine that analyzes and extracts relevant data from a target application programming interface that performs a service on a target data processing system, such as service B 510 on data processing system B 506. Discovery module 526 performs a targeted discovery on data processing system B 506 to determine how the target application programming interface corresponding to service B 510 performs the task of generating the incident ticket on data processing system B 506. Afterward, discovery module 526 sends the discovery information to application programming interface call integration manager 518.

Application programming interface call integration manager 518 utilizes the discovery information to select an appropriate application programming interface call integration pattern from the identified set of application programming interface call integration patterns. Application programming interface call integration manager 518 then forwards the selected application programming interface call integration pattern to transformer module 528. Transformer module 528 may be, for example, an application programming interface call transformation module. Transformer module 528 utilizes the selected application programming interface call integration pattern to transform service request with application programming interface call and associated data 512 into service request with transformed application programming interface call and associated data 532. Service request with transformed application programming interface call and associated data 532 may be, for example, transformed service request 228, which includes transformed application programming interface call and associated data 230, in FIG. 2.

Transformer module 528 forwards service request with transformed application programming interface call and associated data 532 to sender module 530. Sender module 530 establishes and holds a connection with data processing system B 506 and sends service request with transformed application programming interface call and associated data 532 to data processing system B 506 for incident ticket generation task performance by service B 510. Subsequently, service B 510 sends result 534 to service A 508. Result 534 may be, for example, task result 232 in FIG. 2. Result 534, based on the example above, may be an indication that the incident ticket was generated on data processing system B 506.

However, it should be noted that using a different example, result 534 may contain data, such as online credit card purchase verification and authorization information, that service A 508 may require to perform its respective function of completing a transaction with a customer data processing device, such as a smart phone (e.g., local computing device 320A in FIG. 3). In this example, result 534 is sent to service A 508 via listener module 536, parser module 538, application programming interface call integration manager 518, transformer module 540, and sender module 542 to transform the call to the application programming interface corresponding to service A 508 into a call that the application programming interface corresponding to service A 508 can read and use. It should be noted that listener module 536, parser module 538, transformer module 540, and sender module 542 are the same as listener module 514, parser module 516, transformer module 528, and sender module 530, except in reverse order. Further, it should be noted that listener module 514, parser module 516, transformer module 528, and sender module 530 may be included in and components of application programming interface call integration manager 518.

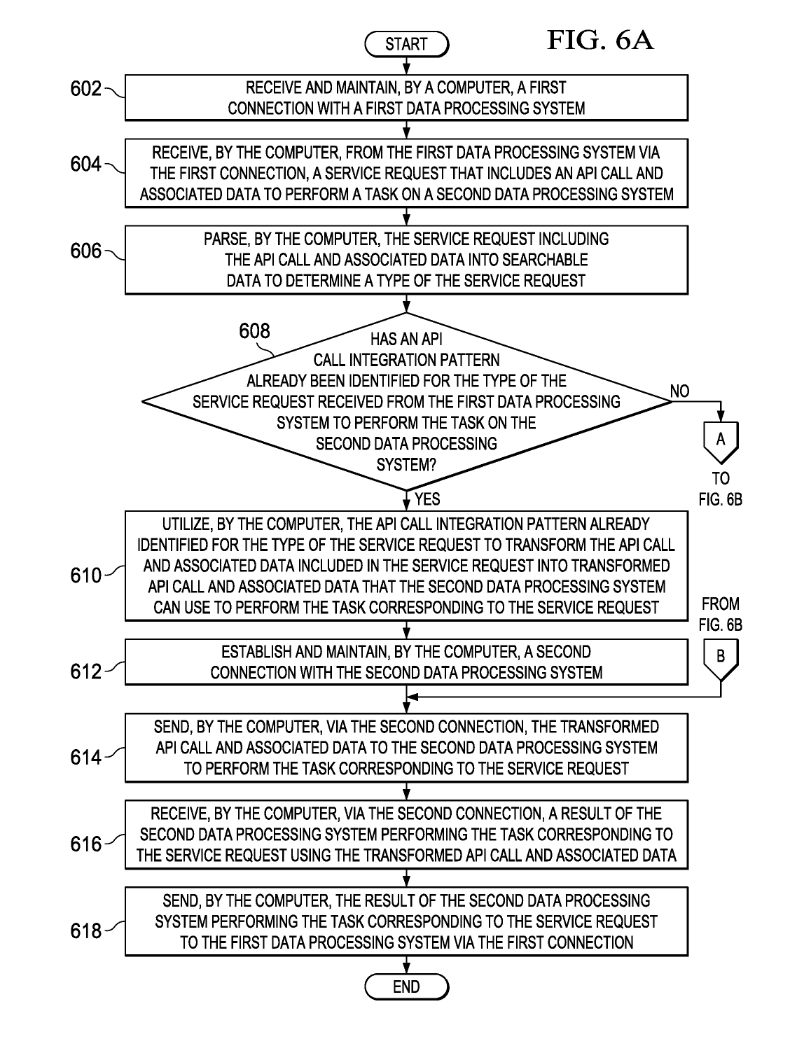

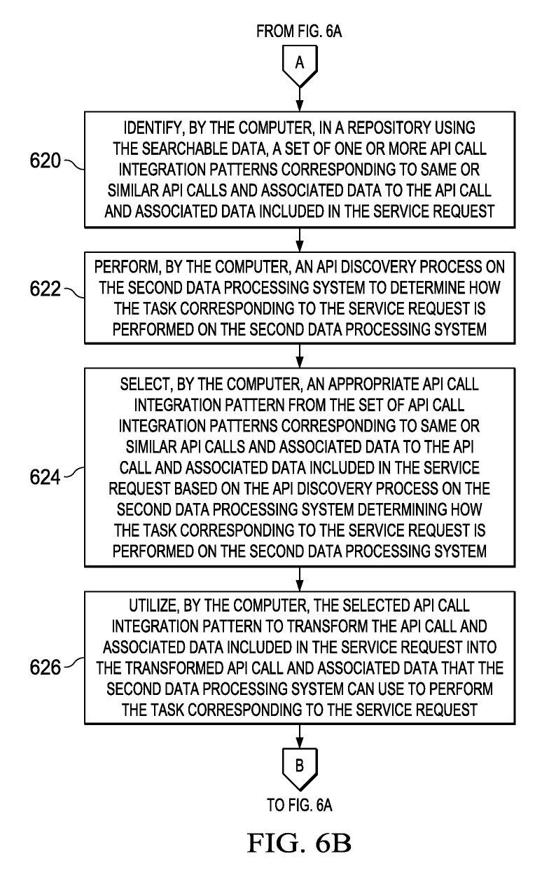

With reference now to FIGS. 6A-6B, a flowchart illustrating a process for transforming application programming interface calls and associated data is shown in accordance with an illustrative embodiment. The process shown in FIGS. 6A-6B may be implemented in a computer, such as, for example, server 104 in FIG. 1, data processing system 200 in FIG. 2, or a cloud computing node in cloud computing nodes 310 in FIG. 3.

The process begins when the computer receives and maintains a first connection with a first data processing system (step 602). The first data processing system may be, for example, data processing system A 504 in FIG. 5. In addition, the computer receives from the first data processing system, via the first connection, a service request that includes an application programming interface (API) call and associated data to perform a task on a second data processing system (step 604). The service request that includes the application programming interface call and associated data may be, for example, service request with API call and associated data 512 in FIG. 5. The second data processing system may be, for example, data processing system B 506 in FIG. 5.

The computer parses the service request including the application programming interface call and associated data into searchable data to determine a type of the service request (step 606). Further, the computer makes a determination as to whether the computer has already identified an application programming interface call integration pattern for the determined type of the service request received from the first data processing system to perform the task on the second data processing system (step 608). The application programming interface call integration pattern may be, for example, API call integration pattern 226 in FIG. 2. If the computer determines that an application programming interface call integration pattern has already been identified for the type of the service request received from the first data processing system to perform the task on the second data processing system, yes output of step 608, then the computer utilizes the application programming interface call integration pattern already identified for the type of the service request to transform the application programming interface call and associated data included in the service request into transformed application programming interface call and associated data that the second data processing system can use to perform the task corresponding to the service request (step 610).

The computer establishes and maintains a second connection with the second data processing system (step 612). In addition, the computer sends, via the second connection, the transformed application programming interface call and associated data to the second data processing system to perform the task corresponding to the service request (step 614). The transformed application programming interface call and associated data may be, for example, service request with transformed API call and associated data 532 in FIG. 5. Subsequently, the computer receives, via the second connection, a result of the second data processing system performing the task corresponding to the service request using the transformed application programming interface call and associated data (step 616). The result may be, for example, result 534 in FIG. 5. The computer sends the result of the second data processing system performing the task corresponding to the service request to the first data processing system via the first connection (step 618). Thereafter, the process terminates.

Returning again to step 608, if the computer determines that an application programming interface call integration pattern has not been identified for the type of the service request received from the first data processing system to perform the task on the second data processing system, no output of step 608, then the computer identifies, in a repository using the searchable data, a set of one or more application programming interface call integration patterns corresponding to same or similar application programming interface calls and associated data to the application programming interface call and associated data included in the service request (step 620). The repository may be, for example, repository of API calls and integration patterns 522 in FIG. 5. Furthermore, the computer performs an application programming interface discovery process on the second data processing system to determine how the task corresponding to the service request is performed on the second data processing system (step 622).

Afterward, the computer selects an appropriate application programming interface call integration pattern from the set of application programming interface call integration patterns corresponding to same or similar application programming interface calls and associated data to the application programming interface call and associated data included in the service request based on the application programming interface discovery process on the second data processing system determining how the task corresponding to the service request is performed on the second data processing system (step 624). The computer utilizes the selected application programming interface call integration pattern to transform the application programming interface call and associated data included in the service request into the transformed application programming interface call and associated data that the second data processing system can use to perform the task corresponding to the service request (step 626). Thereafter, the process returns to step 614 where the computer sends the transformed application programming interface call and associated data to the second data processing system.

Thus, illustrative embodiments of the present invention provide a computer-implemented method, computer system, and computer program product for transforming an application programming interface call and associated data, which are included in a service request received from a source data processing system to perform a task or function on a target data processing system, into a transformed application programming interface call and associated data that the target data processing system can utilize to perform the task or function corresponding to the service request by using an application programming interface call integration pattern corresponding to same or similar application programming interface calls and associated data to the application programming interface call and associated data included in the service request. The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for transforming application programming interface calls, the computer-implemented method comprising:
performing, by a computer, an application programming interface discovery process on a second data processing system to determine how a task corresponding to a service request received from a first data processing system is performed on the second data processing system;
selecting, by the computer, an application programming interface call integration pattern from a set of application programming interface call integration patterns, the selected application programming interface call integration pattern corresponding to application programming interface calls and associated data that are same or similar to an application programming interface call and associated data included in the service request received from the first data processing system, based on the application programming interface discovery process on the second data processing system determining how the task corresponding to the service request is performed on the second data processing system; and
utilizing, by the computer, the selected application programming interface call integration pattern to transform the application programming interface call and associated data included in the service request received from the first data processing system into a transformed application programming interface call and associated data that the second data processing system uses to perform the task corresponding to the service request.

2. The computer-implemented method of claim 1 further comprising:
sending, by the computer, the transformed application programming interface call and associated data via a network to the second data processing system to perform the task corresponding to the service request;
receiving, by the computer, via the network, a result of the second data processing system performing the task corresponding to the service request using the transformed application programming interface call and associated data; and
sending, by the computer, the result of the second data processing system performing the task corresponding to the service request to the first data processing system via the network.

3. The computer-implemented method of claim 1 further comprising:
parsing, by the computer, the service request including the application programming interface call and associated data into searchable data to determine a type of the service request.

4. The computer-implemented method of claim 3, wherein the computer utilizes natural language processing to parse the service request including the application programming interface call and associated data into the searchable data.

5. The computer-implemented method of claim 3 further comprising:
responsive to the computer determining that an application programming interface call integration pattern has not been identified for the type of the service request received from the first data processing system to perform the task on the second data processing system, identifying, by the computer using the searchable data, the set of application programming interface call integration patterns corresponding to the application programming interface calls and associated data that are the same or similar to the application programming interface call and associated data included in the service request.

6. The computer-implemented method of claim 5, wherein the computer performs application programming interface discovery via patterns with focused search exploration limiting a number of application programming interfaces and associated data that the computer has to look at which decreases processor utilization saving computer resources and increasing performance of the computer, itself.

7. The computer-implemented method of claim 3 further comprising:
responsive to the computer determining that an application programming interface call integration pattern has been identified for the type of the service request received from the first data processing system to perform the task on the second data processing system, utilizing, by the computer, the application programming interface call integration pattern identified for the type of the service request to transform the application programming interface call and associated data included in the service request into transformed application programming interface call and associated data that the second data processing system uses to perform the task corresponding to the service request.

8. The computer-implemented method of claim 1, wherein the computer generates the application programming interface call integration pattern based on the application programming interface discovery process performed on the second data processing system.

9. The computer-implemented method of claim 1, wherein the application programming interface call integration pattern is an abstraction of application programming interface code for a target application programming interface on the second data processing system that corresponds to the application programming interface call and associated data included in the service request received from the first data processing system, and wherein the abstraction is a generalization of the target application programming interface away from any specific implementation.

10. The computer-implemented method of claim 9, wherein the application programming interface call integration pattern that provides the abstraction is application programming interface provider agnostic.

11. The computer-implemented method of claim 1, wherein the computer, the first data processing system, and the second data processing system are located in a cloud environment.

12. A computer system for transforming application programming interface calls, the computer system comprising:
a bus system;
a storage device connected to the bus system, wherein the storage device stores program instructions; and
a processor connected to the bus system, wherein the processor executes the program instructions to:
perform an application programming interface discovery process on a second data processing system to determine how a task corresponding to a service request received from a first data processing system is performed on the second data processing system;
select an application programming interface call integration pattern from a set of application programming interface call integration patterns, the selected application programming interface call integration pattern corresponding to application programming interface calls and associated data that are same or similar to an application programming interface call and associated data included in the service request received from the first data processing system, based on the application programming interface discovery process on the second data processing system determining how the task corresponding to the service request is performed on the second data processing system; and
utilize the selected application programming interface call integration pattern to transform the application programming interface call and associated data included in the service request received from the first data processing system into a transformed application programming interface call and associated data that the second data processing system uses to perform the task corresponding to the service request.

13. The computer system of claim 12, wherein the processor further executes the program instructions to:
send the transformed application programming interface call and associated data via a network to the second data processing system to perform the task corresponding to the service request;
receive, via the network, a result of the second data processing system performing the task corresponding to the service request using the transformed application programming interface call and associated data; and
send the result of the second data processing system performing the task corresponding to the service request to the first data processing system via the network.

14. The computer system of claim 12, wherein the processor further executes the program instructions to:
parse the service request including the application programming interface call and associated data into searchable data to determine a type of the service request.

15. The computer system of claim 14, wherein the computer system utilizes natural language processing to parse the service request including the application programming interface call and associated data into the searchable data.

16. The computer system of claim 14, wherein the processor further executes the program instructions to:
identify, using the searchable data, the set of application programming interface call integration patterns corresponding to the application programming interface calls and associated data that are the same or similar to the application programming interface call and associated data included in the service request in response to determining that an application programming interface call integration pattern has not been identified for the type of the service request received from the first data processing system to perform the task on the second data processing system.

17. A computer program product for transforming application programming interface calls, the computer program product comprising a computer readable storage medium having program instructions embodied therewith, the program instructions executable by a computer to cause the computer to perform a method comprising:
performing, by the computer, an application programming interface discovery process on a second data processing system to determine how a task corresponding to a service request received from a first data processing system is performed on the second data processing system;
selecting, by the computer, an application programming interface call integration pattern from a set of application programming interface call integration patterns, the selected application programming interface call integration pattern corresponding to application programming interface calls and associated data that are same or similar to an application programming interface call and associated data included in the service request received from the first data processing system, based on the application programming interface discovery process on the second data processing system determining how the task corresponding to the service request is performed on the second data processing system; and
utilizing, by the computer, the selected application programming interface call integration pattern to transform the application programming interface call and associated data included in the service request received from the first data processing system into a transformed application programming interface call and associated data that the second data processing system uses to perform the task corresponding to the service request.

18. The computer program product of claim 17 further comprising:
sending, by the computer, the transformed application programming interface call and associated data via a network to the second data processing system to perform the task corresponding to the service request;
receiving, by the computer, via the network, a result of the second data processing system performing the task corresponding to the service request using the transformed application programming interface call and associated data; and
sending, by the computer, the result of the second data processing system performing the task corresponding to the service request to the first data processing system via the network.

19. The computer program product of claim 17 further comprising:
parsing, by the computer, the service request including the application programming interface call and associated data into searchable data to determine a type of the service request.

20. The computer program product of claim 19, wherein the computer utilizes natural language processing to parse the service request including the application programming interface call and associated data into the searchable data.

21. The computer program product of claim 19 further comprising:
responsive to the computer determining that an application programming interface call integration pattern has not been identified for the type of the service request received from the first data processing system to perform the task on the second data processing system, identifying, by the computer using the searchable data, the set of application programming interface call integration patterns corresponding to the application programming interface calls and associated data that are the same or similar to the application programming interface call and associated data included in the service request.

22. The computer program product of claim 19 further comprising:
responsive to the computer determining that an application programming interface call integration pattern has been identified for the type of the service request received from the first data processing system to perform the task on the second data processing system, utilizing, by the computer, the application programming interface call integration pattern identified for the type of the service request to transform the application programming interface call and associated data included in the service request into transformed application programming interface call and associated data that the second data processing system uses to perform the task corresponding to the service request.

23. The computer program product of claim 19 further comprising:
responsive to the computer determining that an application programming interface call integration pattern has been identified for the type of the service request received from the first data processing system to perform the task on the second data processing system, utilizing, by the computer, the application programming interface call integration pattern identified for the type of the service request to transform the application programming interface call and associated data included in the service request into transformed application programming interface call and associated data that the second data processing system uses to perform the task corresponding to the service request.

24. The computer program product of claim 17, wherein the computer generates the application programming interface call integration pattern based on the application programming interface discovery process performed on the second data processing system.

25. The computer program product of claim 17, wherein the application programming interface call integration pattern is an abstraction of application programming interface code for a target application programming interface on the second data processing system that corresponds to the application programming interface call and associated data included in the service request received from the first data processing system, and wherein the abstraction is a generalization of the target application programming interface away from any specific implementation.
